(19) United States
(12) Patent Application Publication
(10) Pub. No.: US 2009/0043529 A1
(43) Pub. Date: Feb. 12, 2009

(54) SYSTEM AND METHOD FOR TESTING AN ACCURACY OF A REAL TIME CLOCK

(75) Inventors: Wei-Yuan CHEN, Tu-Cheng (TW); Chun-Te YEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/168,850

(22) Filed: Jul. 7, 2008

(30) Foreign Application Priority Data
Aug. 10, 2007 (CN) 200710201333.0

(51) Int. Cl. G06F 19/00

(52) U.S. Cl. 702/125

(57) ABSTRACT

A method for testing an accuracy of a real time clock is provided. The method includes: applying parameters that comprise a predetermined repetition count on testing the RTC, a predetermined time period, and an acceptable error margin of the RTC; communicating with a local network time protocol (NTP) server for acquiring a system time of the local NTP server; applying a current time of the RTC according to the system time at the beginning of testing the accuracy of the RTC; acquiring the current system time of the local NTP server when the predetermined time period lapse; computing a time difference between the system time of the local NTP server and the current time of the RTC; and determining if the RTC is accurate or not by comparing the time difference and the acceptable error margin, and generating a testing result according to the determination.

### BACKGROUND

1. Field of the Invention

Embodiments of the present disclosure relate to testing real time clocks (RTC), and more particularly to systems and methods for testing an accuracy of a real time clock.

2. Description of Related Art

Real time clocks (RTCs) are used in many electronic products, such as personal computers, mobile phones, and computer servers which require accurate time measurements. For this reason, it is common to test how accurate RTCs are in such electronic products.

In the past, testing an accuracy of a RTC is typically done using a manual method. In one such method, an operator may first adjust a time of the RTC according to a time of a reference clock, and then compare the time of the RTC with the time of the reference clock after a test period (such as 5 seconds, 10 minutes, or 24 hours, for example).

However, the above manual method is error prone. Errors may result because the above-described method only uses a start time and an end time of the method to test the accuracy of the RTC. Accordingly, manually testing one RTC after another results in low efficiency.

What is needed, therefore, is a system and method for testing an accuracy of a RTC, which can automatically test the RCT, so as to improve efficiency and validity of testing the accuracy of the RTC.

### SUMMARY

A system for testing an accuracy of a real time clock (RTC) is provided. The RTC is in electronic communication between a local network time protocol (NTP) server and a national standard time NTP server. The system includes a parameter applying module, a time acquiring module, a synchronizing module, a computing module, and a determining module. The parameter applying module is configured for applying parameters between the local NTP server, the national standard time NTP sever, and the RTC, wherein the parameters comprise a predetermined repetition count, a predetermined time period, and an acceptable error margin of the RTC. The time acquiring module is configured for communicating with the local NTP server for acquiring a system time of the local NTP server at the predetermined time period. The synchronizing module is configured for applying a current time of the RTC according to the system time of the local NTP server. The computing module is configured for computing a time difference between the system time of the local NTP server and the current time of the RTC after a lapse of the predetermined time period. The determining module is configured for determining an accuracy of the RTC, wherein the determining comprises comparing the time difference against the acceptable error margin.

Other advantages and novel features will become more apparent from the following detailed description certain inventive embodiments of the present disclosure when taken in conjunction with the accompanying drawings, in which:

### BRIEF DESCRIPTION OF THE DRAWINGS

FIG. 1 is a schematic diagram of one embodiment of a system for testing an accuracy of a real time clock;

FIG. 2 is a block diagram of one embodiment of a testing unit in FIG. 1 comprising software function modules; and

FIG. 3 is a flowchart illustrating one embodiment of a method for testing an accuracy of a real time clock.

### DETAILED DESCRIPTION OF CERTAIN INVENTIVE EMBODIMENTS

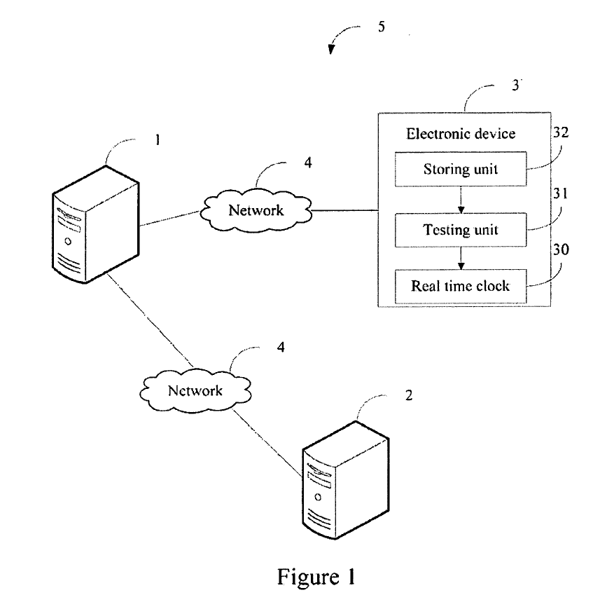

FIG. 1 is a schematic diagram of one embodiment of a system 5 for testing an accuracy of a real time clock. In one embodiment, the system 5 includes a local network time protocol (NTP) server 1, a national standard NTP server 2, and an electronic device 3. The local NTP server 1 connects to the national standard NTP server 2 via a network 4, and is configured for acquiring a national standard time from the national standard NTP server 2. A system time of the local NTP server 1 is adjustable according to the national standard time. The network 4 may be the Internet or an intranet, for example. The electronic device 3 connects with the local NTP server 1 via the network 4, and communicates with the local NTP server 1 for acquiring a system time of the local NTP server 1 through a simple network time protocol (SNTP).

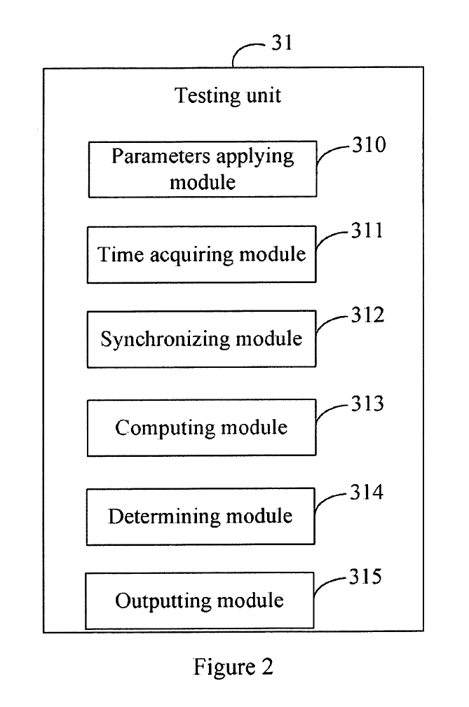

In one embodiment, the electronic device 3 includes a RTC 30, a testing unit 31, and a storing unit 32. An accuracy of the RTC 30 is tested via a system and method as will be further described herein. The testing unit 31 includes a plurality of software function modules that are configured for testing the accuracy of the RTC 30. Further details of the software function modules of the testing unit will be explained with respect to FIG. 2.

FIG. 2 is a block diagram of one embodiment of the testing unit 31 in FIG. 1 comprising software function modules. In one embodiment, the software function modules include a parameter applying module 310, a time acquiring module 311, a synchronizing module 312, a computing module 313, a determining module 314, and an outputting module 315. The modules 310, 311, 312, 313, 314, and 315 recited above perform one or more tasks for testing an accuracy of the RTC 30. It may be understood that one or more specialized or general purpose processors (not shown) in the electronic device 3 may be used to execute the software function modules 310, 311, 312, 313, 314, 315.

The parameter applying module 310 is configured for applying parameters to the electronic device 3, the local NTP server 1, and the national standard NTP server 2 so as to test an accuracy of the RTC 30. In one embodiment, the parameters may include a predetermined repetition count, a predetermined time period, and an acceptable error margin of the RTC 30. The parameters are stored in the storing unit 32. The plurality of parameters may be defined by a user or be defaulted to one or more predetermined parameters depending on the embodiment. It may be understood that the acceptable error margin may define a number or a range of numbers that may be an acceptable time difference between a system time of the local NTP 1 and a current time of the RTC 30. The predetermined repetition count may define how many times the RTC 30 needs to be tested in order to test an accuracy of the RTC 30. The predetermined time period may define a gap in time between two tests of the RTC 30.

The time acquiring module 311 is configured for communicating with the local NTP server 1 for acquiring a system time of the local NTP server 1 at the predetermined time period.

The synchronizing module 312 is configured for applying a current time of the RTC 30 according to the system time of the local NTP server 1 when the testing unit 31 begins testing an accuracy of the RTC 30.

The computing module 313 is configured for computing a time difference between the system time of the local NTP server 1 and the current time of the RTC 30 when the predetermined time period has lapsed.

The determining module 314 is configured for computing if the time difference computed by the computing module 313 is within the acceptable error margin of the RTC 30. If the time difference is outside the acceptable error margin, then the determining module 314 concludes that the RTC 30 is inaccurate. Otherwise, if the time difference is within the acceptable error margin, then the determining module 313 is further configured for determining if a total completed test count on testing the RTC 30 equals the predetermined repetition count.

In one embodiment if the total completed test count on testing the RTC 30 equals the predetermined repetition count, then the determining module 314 concludes that the RTC 30 is accurate. Otherwise, if the total completed test count on testing the RTC 30 dose not equal the predetermined repetition count, then the computing module 312 computes another time difference when the predetermined time period lapse once more.

The outputting module 315 is configured for generating a test result that indicates if the RTC 30 of the electronic device 3 is accurate or inaccurate. The outputting module is further configured for outputting a test report according to the test result.

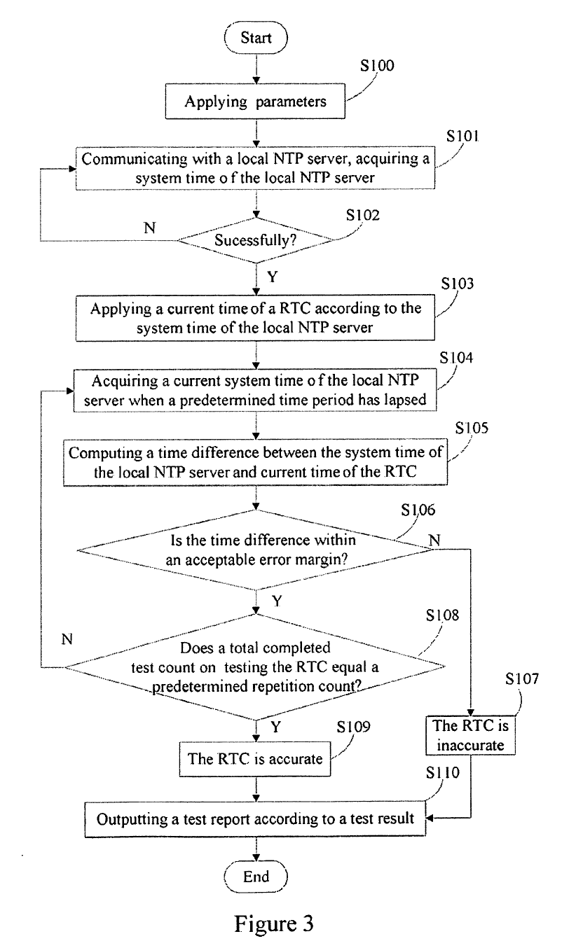

FIG. 3 is a flowchart illustrating one embodiment of a method for testing an accuracy of a real time clock. The method of FIG. 3 may be used for testing an accuracy of a RTC of a mobile phone or an electronic device, for example. Depending on the embodiment, additional blocks may be added, others removed, and the ordering of the blocks may be changed.

In block S100, an operator sets a plurality of parameters through the parameters applying module 310. As mentioned above, the parameters may include a predetermined repetition count, a predetermined time period, and an acceptable error margin of the RTC 30.

In block S101, the time acquiring module 311 communicates with the local NTP server 1 in order to acquire a system time of the local NTP server 1.

In block S102, the determining module 314 determines if the system time has been acquired successfully. If the system time has been acquired successfully, in block S103, then the synchronizing module 312 applying a current time of the RTC 30 according to the system time.

In block S104, the time acquiring module 311 communicates with the local NTP server 1 in order to acquire another system time of the local NTP server 1 when a predetermined time period has lapsed.

In block S105, the computing module 313 computes a time difference between the system time and a current time of the RTC 30.

In block S106, the determining module 314 determines if the time difference is within the acceptable error margin of the RTC 30. If the time difference is outside the acceptable error margin, in block S107, then the determining module 314 concludes that the RTC 30 is inaccurate. Otherwise, if the time difference is within the acceptable error margin, in block S108, the determining module 313 further determines if a total completed test count on testing the RTC 30 equals the predetermined repetition count.

As mentioned above, if the total completed test count on testing the RTC 30 equals the predetermined repetition count, in block S109, then the determining module 314 concludes that the RTC 30 is accurate. Otherwise, if the total completed test count on testing the RTC 30 dose not equal the predetermined repetition count, then the flow returns to block S104 as described above, and the computing module 312 computes another time difference for the predetermined time period lapse.

In block S110, the outputting module 315 generates a test result to indicate the RTC 30 is accurate or inaccurate, and then outputs a test report according to the test result. The test result and the test report may be stored in the storing unit 32 in one embodiment.

The system 5 improves efficiency and accuracy of the RTC 30 of the electronic device 3. It may be appreciated that the electronic device 3 may be a device that requires a constant accurate RTC value. Accurate RTC values may improve power consumption and allow the electronic device 3 to focus computing time on other system tasks.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for testing an accuracy of a real time clock (RTC), the RTC in electronic communication between a local network time protocol (NTP) server and a national standard time NTP server, the system comprising:
a parameter applying module configured for applying parameters between the local NTP server, the national standard time NTP sever, and the RTC, wherein the parameters comprise a predetermined repetition count, a predetermined time period, and an acceptable error margin of the RTC;
a time acquiring module configured for communicating with the local NTP server for acquiring a system time of the local NTP server at the predetermined time period;
a synchronizing module configured for applying a current time of the RTC according to the system time of the local NTP server;
a computing module configured for computing a time difference between the system time of the local NTP server and the current time of the RTC after a lapse of the predetermined time period; and
a determining module configured for determining an accuracy of the RTC, wherein the determining comprises comparing the time difference against the acceptable error margin.

2. The system of claim 1, wherein the time acquiring module acquires the system time from the local NTP server through a simple network time protocol.

3. The system of claim 1, wherein the determining module is further configured for determining if a total completed test count on testing the RTC equals the predetermined repetition count.

4. The system of claim 1 further comprising:
an outputting module configured for generating a test result that indicates the a test result of the determining module, and configured for outputting a test report according to the test result.

5. A computer-implemented method for testing an accuracy of a real time clock (RTC), the method comprising:
applying a plurality of parameters for the RTC, wherein the plurality of parameters comprise a predetermined repetition, a predetermined time period, and an acceptable error margin of the RTC;
communicating with a local network time protocol (NTP) server for acquiring a system time of the local NTP server;
applying the system time of the local NTP server to a current time of the RTC
communicating with the local NTP server for acquiring a system time of the local NTP server after a predetermined time period;
computing a time difference between the system time of the local NTP server and a current time of the RTC; and
determining an accuracy of the RTC by comparing the time difference against the acceptable error margin of the RTC, and generating a testing result according to the determination.

6. The method of claim 5, before the block of applying a plurality of parameters, further comprising:
connecting the local NTP server to a national standard NTP server via a network;
acquiring a national standard time from the national standard NTP server; and
adjusting a system time of the local NTP server according to the national standard time.

7. The method of claim 5, wherein the block of determining comprises:
determining that the RTC is inaccurate upon the condition that the time difference is outside the acceptable error margin;
determining if a total completed test count of the RTC equals the predetermined repetition count upon the condition that the difference is less than the acceptable error margin; and
determining that the RTC is accurate when the total completed test count on testing the RTC equals the predetermined repetition count.

8. The method of claim 5, further comprising:
outputting a test report according to the test result that indicates the RTC is one of an accurate or inaccurate.

9. A computer-readable medium having stored thereon instructions, the computer-readable medium, when executed by a computer, causing the computer to perform a method for testing an accuracy of a real time clock, the method comprising:
applying a plurality of parameters for the RTC, wherein the plurality of parameters comprise a predetermined repetition, a predetermined time period, and an acceptable error margin of the RTC;
communicating with a local network time protocol (NTP) server for acquiring a system time of the local NTP server;
applying the system time of the local NTP server to a current time of the RTC communicating with the local NTP server for acquiring the system time of the local NTP server after a predetermined time period;
computing a time difference between the system time of the local NTP server and the current time of the RTC; and
determining an accuracy of the RTC by comparing the time difference against the acceptable error margin of the RTC, and generating a testing result according to the determination.

10. The computer-readable medium having stored thereon instructions of claim 9, before the block of applying a plurality of parameters, the method performed by the computer further comprising:
connecting the local NTP server to a national standard NTP server via a network;
acquiring a national standard time from the national standard NTP server; and
adjusting a system time of the local NTP server according to the national standard time.

11. The computer-readable medium having stored thereon instructions of claim 9, wherein the block of determining comprises:
determining that the RTC is inaccurate, upon the condition that the time difference is outside the acceptable error margin;
determining if a total completed test count of the RTC equals the predetermined repetition count, upon the condition that the difference is less than the acceptable error margin; and
determining that the RTC is accurate when the total completed test count on testing the RTC 30 equals the predetermined repetition count.

12. The computer-readable medium having stored thereon instructions of claim 9, the method performed by the computer further comprising:
outputting a test report according to the test result, which indicates the RTC is accurate or inaccurate.
